(19) United States
(12) Patent Application Publication
(10) Pub. No.: US 2025/0075986 A1
(43) Pub. Date: Mar. 6, 2025

(54) HEAT EXCHANGERS WITH MODULAR CORES AND METHODS OF MAKING THE SAME

(71) Applicant: MEGGITT AEROSPACE LIMITED, COVENTRY (GB)

(72) Inventors: CHRISTOPHER SIMON ELLIOTT, REDDITCH (GB); SILVIU-CRISTIAN VAIDEANU, HAMPSHIRE (GB); CHRISTIOPHER CHARLES HOOD, LEICESTERSHIRE (GB); NUNO FRAGOSO DE CARVALHO, COVENTRY (GB)

(21) Appl. No.: 18/457,302

(22) Filed: Aug. 28, 2023

(51) Int. Cl. F28F 9/00; F28D 1/053

(52) U.S. Cl. CPC F28F 9/002; F28D 1/05366; F28F 2009/004

(57) ABSTRACT

Heat exchangers and methods of making heat exchangers are discussed herein. The heat exchangers are unique in that they comprise a plurality of heat exchanger cores mechanically coupled to a structural frame that may be comprised by a distribution header to form an array of heat exchanger cores. In preferred embodiments, each core has one or more mounting interfaces that includes at least one input port and output port and is coupled to the distribution header in a removeable configuration via a face seal. In preferred embodiments, the heat exchanger cores are cantilevered from the structural support or distribution header.

### FIELD

The present patent document relates to new designs for heat exchanges and in particular, novel designs for constructing heat exchangers with modular heat exchanger cores.

### BACKGROUND

In recent times, there has been a transition from manufacturing heat exchangers using traditional methods to the use of additive manufacturing methods. Additive manufacture is an attractive and exciting means by which to make heat exchangers but it creates a number of issues.

The use of additive manufacture has the possibility of reducing the assembly to a much smaller number of components. A reduction of components is just one of the advantages of using additive manufacturing to make heat exchangers. Ideally, the heat exchanger would be a single component. However, it is often not possible to make the heat exchanger as a single component when using additive manufacturing.

There are many technical difficulties in the execution of heat exchangers using additive manufacture, amongst which is the limited size of components, which can be manufactured. Larger heat exchangers would need to be manufactured as multiple sections which would need to be joined together.

Joints created to couple various different heat exchanger components together after they have been additively manufactured need to be robust and reliable; especially in harsh environments, such as an aircraft engine. The aluminum alloys used in additive manufacture (e.g. AlSi10Mg) are typically unsuited for welding or brazing. The low magnesium content typical in additive manufacture aluminum alloys leads to weld porosity and the low melting temperature precludes brazing due to this being too close to that of the braze filler alloy.

Demountable fixtures would permit components to be replaced for repair and overhaul purposes. Permanent fixtures may also be acceptable. What is needed is designs and methods of manufacturer for heat exchangers that allow heat exchangers to be additively manufactured in components and assembled together.

### SUMMARY OF THE EMBODIMENTS

A novel heat exchanger is described and provided herein. In preferred embodiments, a plurality of heat exchanger cores are mechanically coupled to a structural support or distribution header that has been designed to be a structural support, to form an array of heat exchanger cores.

In preferred embodiments, the heat exchanger assembly comprises a structural support with a plurality of first mating interfaces wherein the plurality of first mating interfaces has a plurality of input ports and a plurality of output ports across the assembly designed to support multiple heat exchanger cores.

Attached to the structural support is an array of heat exchanger cores wherein each heat exchanger core in the array of heat exchanger cores comprises: 1.) one or more second mating interfaces; and 2.) at least one core input port and at least core output port.

In preferred embodiments, each heat exchanger core in the array of heat exchanger cores is rigidly affixed in a removable configuration to the structural support. Face seals are used between the interfaces on the structural support and heat exchanger course to fluidly couple input and output ports on the structural support or header to the input and output ports on the heat exchanger cores.

In preferred embodiments, each heat exchanger core in the plurality of heat exchanger cores is cantilevered from the structural support. Also in preferred embodiments, each heat exchanger core has an identical construction to reduce part numbers and allow interchanging of parts.

In preferred embodiments, fasteners are used to couple each heat exchanger core in the plurality of heat exchanger cores to the structural support. While any type of fasteners may be used, bolts are preferred. In some embodiments, each first mating interface on the structural support or distribution header is flange shaped and the bolts pass through each first mating interface and into threads in each heat exchanger core in a plurality of heat exchanger cores.

Although any number of interfaces may be used on each heat exchanger core, in preferred embodiments, each heat exchanger core in the plurality of heat exchanger cores has two mating interfaces. In such embodiments, each of the two mating interfaces may have a core input port and a core output port. In other embodiments, each mating interface may only have a single port or may have multiple ports more than two.

In preferred embodiments, the distribution header itself serves as the structural support. In such cases, the distribution header may be constructed in a fashion, such as by creating thicker walls or sections, to strengthen the structure. In other embodiments, the structural support may be integrated into the distribution header but is still created as single piece. In still yet other embodiments, a distribution header may be attached onto a structural support as a separate part.

In the primarily implementation, the designs herein are to be used with the additive manufacturing process, although not required. To this end, in preferred embodiments, each heat exchanger core in the plurality of heat exchanger cores is a single piece construction. Similarly, the distribution header and/or structural support may be created as a single piece construction using additive manufacturing.

In some embodiments, the structural support and/or distribution header is in the shape of an arc and each heat exchanger core in the plurality of heat exchanger cores is trapezoid shaped.

### BRIEF DESCRIPTION OF THE DRAWINGS

FIG. 1 illustrates a plan view of a heat exchanger assembly with a plurality of fan shaped cores arrayed inward from a curved header;

FIG. 2 illustrates and isometric view of a single heat exchanger core element from an array of heat exchanger core elements for use in a heat exchanger such as the one shown in FIG. 1;

FIG. 3 illustrates an isometric view of a heat exchanger assembly with a plurality of fan shaped cores arrayed inward from a curved header.

### DETAILED DESCRIPTION OF THE DRAWINGS

This patent document describes embodiments of heat exchangers that can overcome the problems of creating a large heat exchanger assembly from components that have been primarily manufactured by additive manufacturing methods. In the embodiments described herein, the heat exchanger is a liquid to gas heat exchanger whereby the liquid is at a high pressure and the gas is at low pressure. Other embodiments may have any combination of gasses, liquids and super-critical fluids. In the embodiments described herein, the respective fluids are in a counter flow arrangement. Other embodiments may be cross- and parallel-flow.

The general arrangement described herein is for a structural frame from which a plurality of heat exchanger cores are mounted to form an array of cores. Creating an array of heat exchanger cores, replaces/eliminates many of the issues normally found in large heat exchangers for greater volumetric and gravimetric efficiency.

In some embodiments, the frame may include the headers that distribute the fluid to the inlet and outlet ports of each heat exchange core. Alternatively, a plurality of headers and support frames may be used as discrete or combined entities.

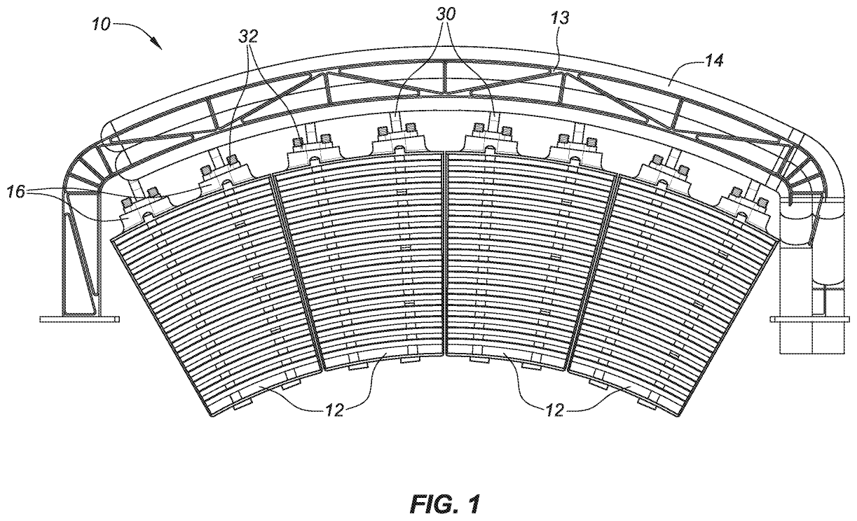

FIG. 1 illustrates a plan view of a heat exchanger assembly 10 with a plurality of fan shaped or trapezoid shaped cores 12 arrayed inward from a curved or arc shaped header 14. Other arrangements may include, but are not limited to, curved assemblies where the cores are arrayed outwards, curved array where the cores are on both sides of the header or straight arrays with cores on either or both sides.

As may be seen in FIG. 1, the heat exchanger assembly 10 includes a structural support 13. As used herein, “structural support” means structure design to provide rigidity but does not contribute to the functionality of the heat exchanger 10. In the embodiment shown in FIG. 1, the structural support 13 is separate from the actual curved header 14. However, in some embodiments, the header 14 may be constructed in a manner wherein the header itself provides the structural support.

The embodiment of a heat exchanger assembly 10 shown in [symbol] offers weight and volume reductions compared to conventional installations by removing the conventional headers that are seen on heat exchangers and combining them with the mounting hardware that would be associated with securing a heat exchanger installation in place. Utilising the header as a structural member is efficient because one component is doing a multitude of roles. If the header and support structure are a single entity then the coupling between that entity and each core are serving both as structural and fluid couplings in a single joint.

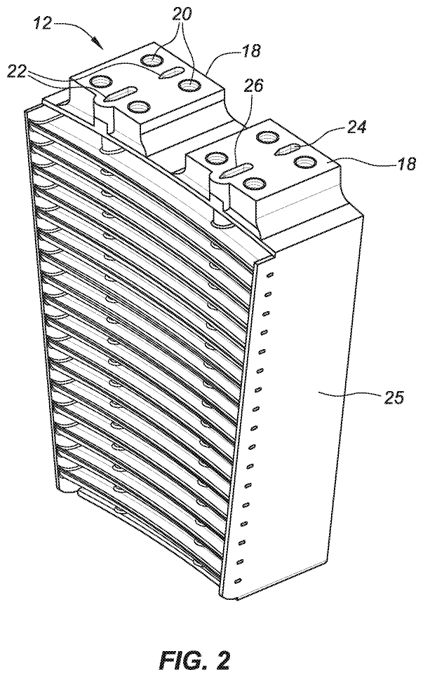

As may be seen in FIG. 1, the structural support 13 or in some embodiments, the header 14. comprises a plurality of first mating interfaces 16. The mating interfaces 16 are designed to interface with corresponding mating interfaces 18 (See FIG. 2) on a plurality of heat exchanger cores 12.

As may be seen in FIG. 1, in some embodiments, the first mating interfaces 16 may be flanges 32 that are cantilevered off the support structure 13 or distribution header 14 with short arms 30. This is just one possible embodiment and numerous other designs are possible. However, as will be discussed below, using a cantilevered design has advantages.

In preferred embodiments, the heat exchanger cores 12 are rigidly affixed in a removable configuration to the structural support 13 or the header 14. In the embodiment 10 shown in FIG. 1. face seals (not shown) are used between the mating interfaces of the support structure 13 or distribution header 14 and the heat exchanger cores 12. In the embodiment shown, each heat exchanger core 14 has two mating interfaces 16 each with at least one face seal. In other embodiments, other numbers of mating interfaces 16 may be used including 1, 3, 4, 5, 6 or more interfaces 16 per heat exchanger core 12. The face seal may be, but is not limited to, o-rings and gaskets.

Once the heat exchanger cores 12 are rigidly affixed to the structural support 13, at least one input port on each heat exchanger core 12 is fluidly coupled to a first output port in the plurality of output ports on the header 14. Similarly, at least one output port on each heat exchanger core 12 is fluidly coupled to a first input port in the plurality of input ports on the header 14.

Each heat exchanger core mates to the distribution header via a plurality of fasteners. In preferred embodiments, the fasteners are bolts that pass through the interface flanges 32 and thread into the heat exchanger core 12. In other embodiments, other types of fasteners may be used such as clamps, various types of threaded fasteners with nuts or without, and other types of screws, clips, clamps, washers, lock washers, or other fasteners. The fasteners, in this embodiment, bolts, hold the mating interfaces on the support structure 13 or distribution header 14 to the mating interfaces on the heat exchanger cores by compressing them together with a face seal in between. This prevents fluid leakage during operation.

FIG. 2 illustrates and isometric view of a single core element 12 from an array of core elements for use in a heat exchanger 10 such as the one shown in FIG. 1. As may be seen in FIG. 2, the core element 12 has two mating interfaces 18 designed to correspond to two mating interfaces 16 on the support structure 13 or distribution header 14. In other embodiments, one mating interface 18 or more than two mating interfaces 18 may be used per core element 12. However, in the preferred embodiment, two mating interfaces 18 are used. The two main functions mating interfaces are: 1.) support the cores; and 2.) as fluid interfaces. A broader footprint is preferred from a structural loads standpoint and multiple fluid couplings may be preferred to prevent flow maldistribution.

As may be appreciated, when face seals are used, it is advantageous to have the mating interfaces 16 and 18 be flat pads with the face seal in between. In some embodiments, one of the mating interface pads may have a groove machined into it to accommodate the face seal.

In the embodiment shown in FIG. 2, each mating interface has two ports 18. One port is an output port 24 for the core module 12 and one port is an input port 26 for the core module 12. As may be appreciated, each core element 12 must have at least two ports, one output port 24 and one input port 26. However, more ports 22 may be used as in the embodiment shown in FIG. 2, where four ports 22 are used for a single core element 12. In other embodiments, more than four ports 22 may be used. It should also be appreciated, that it is not necessary to have two ports 22 per interface 18 and a single port 22 may be used on each interface 18 or more than two ports 22 may be used on an interface 18.

As may be appreciated, how ever many input or output ports are used on the individual core elements 12 or in particular, on the interfaces 18 of the core elements 12, the corresponding mating interface 16 on the structural support 13 or header 14 have complementary ports. As may be appreciated, an output port on the structural support 13 or header 14 would have a complimentary input port on the heat exchanger core 12 and vice versa.

Numerous different types of seals may be used to seal the individual core elements 12 to the heat exchanger 10. The use of face seals allows the centres of the fluid ports 22 to have sufficient float to accommodate positional mismatches caused by the simultaneous mating of multiple ports 22. In some embodiments, the mating plane for each heat exchanger core 12 may be different from those of its neighbours depending on the form of the heat exchanger array 10, with curving arrays like that shown in [symbol] having multiple planes.

In preferred embodiments, the ports 22 for each heat exchanger core 12, and its associated interface on the distribution header, are co-planar by having their mating interfaces machined in a single operation. Having the mating surfaces co-planar means that they are formed in a single operation with the same tool following a continuous cutting path, forcing them to be on a plane. If the machining was done in multiple operations with interrupted cutting paths the co-planar relationship could not be guaranteed. These ports 22 may be on a single pad 18 or split over a plurality of pads 18, as shown in [symbol] .

The heat exchanger cores 12 and/or structural support 13 (including the headers) may be mounted in a manner to facilitate removal of individual elements to make in-situ maintenance operations easier. In preferred embodiments, the cores 12 are cantilevered from the structural support 30. Further embodiments may have a plurality of mounting points when additional support is required. In the preferred embodiment, each heat exchanger core 12 is cantilevered from the support structure 14, which facilitates mounting and access from a single face to assist maintenance operations.

In preferred embodiments, the distribution header may support a plurality of other functions, including but not limited to. flow bypass control, bleed & instrumentation ports and mounting interfaces. The distribution header may be divided into multiple fluid flows to allow more than one heat exchanger function to be accommodated in a single assembly.

Flow control to each core, or a group of cores, may be controlled by installing fluid control valves that actively or passively regulate the flow of fluid in any given core.

In the embodiment shown, a wall, located on the permitter sides of each core, which is integrated into each heat exchanger core as part of the single piece construction, circumscribes each core. To further save weight and assist in space efficient packaging some, or all, of the walls surrounding the core may be removed if they are not required for structural support or to interface directly with any duct walls. Further enhancements may be made to the cores by adding features, such as turning vanes as detailed in US Patent Publication 20210041188, herein incorporated by reference in its entirety, to enhance performance.

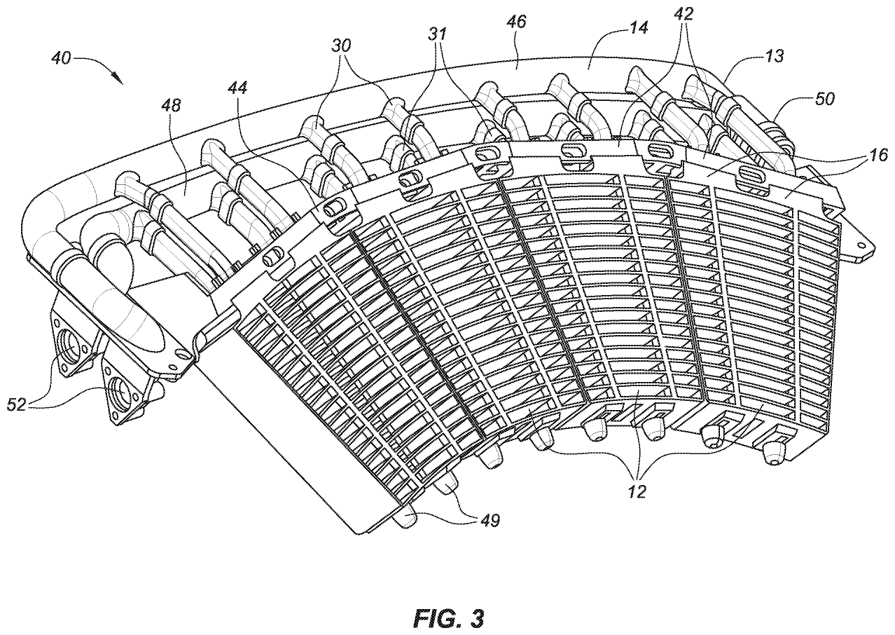

FIG. 3 illustrates an isometric view of a heat exchanger assembly with a plurality of fan shaped cores arrayed inward from a curved header. FIG. 3 is similar to the embodiment shown in FIG. 1 except the structural support is now the support manifold and is a cantilevered structure that extends from the headers as a supporting arch structure. The support manifold is in fluid communication to the inlet header 46 and the outlet header 48.

In the embodiment shown in FIG. 3, the header 14 and the support manifold, which is made up of a plurality of interlocking pieces 42 and 44, combine together to create a structural support 13 for the cores 12. The structural support forms an arch comprised of a plurality of rectangular components 42/44 coupled at their adjacent ends at a slight obtuse angle. The support manifold is made of two different pieces, the interface pieces 42 that directly interface with the cores 12 and the interlocking pieces 44 that bifurcate each set of interface pieces 42 at an obtuse angle to create the curve of the intake manifold.

In the embodiment shown in FIG. 3, each interface piece 44 is connected to the header 14 by short arms 30, which are also flow tubes. The tubes 30 provide the cantilever for the interface pieces 44 and also act as the flow path between the cores 12 and the header 14.

In the embodiment shown in FIG. 3, two tubes 30 connect the input header 46 to each core and two tubes 30 connect the output header 48 to each core 12. In other embodiments, more or less than two tubes may be used to connect each core to either the input header 46 or the output header 48.

In preferred embodiments, the short arms 30 or tubes 30 are structurally strong enough to provide cantilevered support for the cores 12. However, in the embodiment shown in FIG. 3, each core 12 has a plurality of anti-vibration mounts 49 on the opposite end from the mating interfaces 16/18. The anti-vibration mounts 49, connect with rigid structure and help quell vibration modes.

As may be seen in the embodiment shown in FIG. 3, the bypass valve 50 is partially visible on the right and the fluid interfaces 52 are on the left. In some embodiments, a non-rigid/fixed coupling may be used (that doesn't pierce the duct) at other points on the cores 12 to prevent vibration induced movement and/or flow bypassing the cores.

What is claimed is:

1. A heat exchanger assembly comprising:
a structural support with a plurality of first mating interfaces wherein the plurality of first mating interfaces has a plurality of input ports and a plurality of output ports; and
an array of heat exchanger cores wherein each heat exchanger core in the array of heat exchanger cores comprises:
one or more second mating interfaces;
at least one core input port and at least one core output port;
wherein each heat exchanger core in the array of heat exchanger cores is rigidly affixed in a removable configuration to the structural support by coupling with a face seal the one or more second mating interfaces with one or more first mating interfaces from the plurality of first mating interfaces such that the at least one core input port fluidly couples to a first output port in the plurality of output ports and the at least one core output port fluidly couples to a first input port in the plurality of input ports.

2. The heat exchanger assembly of claim 1, wherein each heat exchanger core in the plurality of heat exchanger cores is cantilevered from the structural support.

3. The heat exchanger assembly of claim 2, wherein fasteners are used to couple each heat exchanger core in the plurality of heat exchanger cores to the structural support.

4. The heat exchanger assembly of claim 3, wherein the fasteners are bolts.

5. The heat exchanger assembly of claim 4, wherein each first mating interface in the plurality of first mating interfaces is flange shaped and the bolts pass through each first mating interface and into threads in each heat exchanger core in the plurality of heat exchanger cores.

6. The heat exchanger assembly of claim 2, wherein each heat exchanger core in the plurality of heat exchanger cores has two second mating interfaces.

7. The heat exchanger assembly of claim 6, wherein each of the two second mating interfaces has a core input port and a core output port.

8. The heat exchanger assembly of claim 1, wherein a header is integrated into the structural support and is created as single piece.

9. The heat exchanger assembly of claim 1, wherein each heat exchanger core in the plurality of heat exchanger cores is a single piece construction.

10. The heat exchanger assembly of claim 1, wherein the structural support is in the shape of an arc and each heat exchanger core in the plurality of heat exchanger cores is trapezoid shaped.

11. The heat exchanger assembly of claim 1, wherein each heat exchanger core in the array of heat exchanger cores is identical in construction.

12. A heat exchanger assembly comprising:
a structural support forming an arch comprised of a plurality of rectangular components coupled at their adjacent ends at a slight obtuse angle wherein the structural support has a plurality of first mating interfaces wherein the plurality of first mating interfaces has a plurality of input ports and a plurality of output ports; and
an array of heat exchanger cores wherein each heat exchanger core in the array of heat exchanger cores comprises:
one or more second mating interfaces;
at least one core input port and at least core output port;
wherein each heat exchanger core in the array of heat exchanger cores is rigidly affixed in a removable configuration to the structural support by coupling with a face seal the one or more second mating interfaces with one or more first mating interfaces from the plurality of first mating interfaces such that the at least one core input port fluidly couples to a first output port in the plurality of output ports and the at least one core output port fluidly couples to a first input port in the plurality of input ports.

13. The heat exchanger assembly of claim 12, wherein each heat exchanger core in the plurality of heat exchanger cores is cantilevered from the structural support.

14. The heat exchanger assembly of claim 13, wherein fasteners are used to couple each heat exchanger core in the plurality of heat exchanger cores to the structural support.

15. The heat exchanger assembly of claim 14, wherein the fasteners are bolts.

16. The heat exchanger assembly of claim 15, wherein each first mating interface in the plurality of first mating interfaces is flange shaped and the bolts pass through each first mating interface and into threads in each heat exchanger core in the plurality of heat exchanger cores.

17. The heat exchanger assembly of claim 12, wherein the structural support is coupled both mechanically and fluidly to a header via a plurality of tubes.

18. The heat exchanger assembly of claim 17, wherein there are four tubes for each heat exchanger core in the plurality of heat exchanger cores.

19. A heat exchanger assembly comprising:
a structural support forming an arch comprised of a plurality of rectangular components coupled at their adjacent ends at a slight obtuse angle wherein the structural support has a plurality of first mating interfaces wherein the plurality of first mating interfaces has a plurality of input ports and a plurality of output ports; and
an array of heat exchanger cores wherein each heat exchanger core in the array of heat exchanger cores comprises:
one or more second mating interfaces;
at least one core input port and at least core output port;
wherein each heat exchanger core in the array of heat exchanger cores is rigidly affixed in a removable configuration to the structural support by coupling with a face seal the one or more second mating interfaces with one or more first mating interfaces from the plurality of first mating interfaces such that the at least one core input port fluidly couples to a first output port in the plurality of output ports and the at least one core output port fluidly couples to a first input port in the plurality of input ports; and
wherein the structural support is coupled both mechanically and fluidly to a header via a plurality of tubes.

20. The heat exchanger assembly of claim 19, wherein each heat exchanger core in the plurality of heat exchanger cores is cantilevered from the structural support.
